(19) United States
(12) Patent Application Publication
(10) Pub. No.: US 2007/0195983 A1
(43) Pub. Date: Aug. 23, 2007

(54) Combination wind screen and microphone shock mount

(76) Inventor: Manfred Klemme, Oceanside, CA (US)

Correspondence Address: MARCIA A. DEVON;DEVON & ASSOCIATES, 400 OCEANGATE BLVD., SUITE 800, LONG BEACH, CA, 90802, US

(21) Appl. No.: 11/788,468

(22) Filed: Apr. 20, 2007

Related U.S. Application Data
(63) Continuation-in-part of application No. 11/101,339, filed on Apr. 7, 2005.

(51) Int. Cl. H04R 11/04; H04R 17/02; H04R 19/04; H04R 21/02; H04R 9/08

(52) U.S. Cl. 381/362; 381/361; 381/366

(57) ABSTRACT

A mount for a microphone that includes an optional windscreen is disclosed. The mount includes preferably two resilient microphone supports that each comprise a resilient microphone ring attached to a plurality of resilient ring bands. Each ring can accommodate and frictionally retain microphones of various sizes and diameters. Each microphone support is fixed at a lower end thereof to a microphone support base which has least one mounting aperture therein. The mount further includes an elongated generally cylindrical cage that has a front open end, a rear open end, and an acoustically-permeable rigid wall. A bottom surface of the cage includes a resilient base fixture that includes at least one mounting aperture therein. A pair of reticulated foam hemispheric end caps are preferably included that are slidably, frictionally retained within the open ends of the cage. A rigid, preferably metallic or plastic cage mounting bracket is included that has at least one mounting aperture therein and includes a pivot mounting means. A rigid mounting post is pivotally and selectively fixed to the pivot mounting means of the cage. A pair of mounting bolts are included that secure the cage mounting bracket, the resilient base fixture of the cage, and the microphone support base together. The cage preferably further includes an electric microphone connector that is fixed through the rigid wall of the cage, and a windscreen cover that may be selectively mounted around the cage to provide wind noise dampening.

### CROSS-REFERENCE TO RELATED APPLICATIONS

This application is a continuation-in-part of U.S. patent application Ser. No. 11/101,339, filed Apr. 7, 2005, which is expressly incorporated herein by reference.

### STATEMENT REGARDING FEDERALLY SPONSORED RESEARCH AND DEVELOPMENT

Not Applicable.

### FIELD OF THE INVENTION

This invention relates to microphones, and more particularly to a shock absorbing wind screen microphone mount.

### DISCUSSION OF RELATED ART

A microphone is sensitive to wind noise and mechanical vibration caused by shocks or jolts to a boom or stand supporting the microphone. Various devices in the prior art have been designed to reduce both wind noise and shock-related noise. For example, U.S. Pat. No. 6,459,802 to Young discloses an elastomeric band arrangement for supporting a microphone away from a rigid support stand; U.S. Pat. No. 4,991,220 Wolf discloses an elastic support member for a microphone; and U.S. Pat. No. 4,514,598 to Plice discloses a shock-mounting apparatus for supporting a microphone with elastic bands. The prior devices are not well-suited for use with windscreens which tend to be somewhat bulky. The prior devices provide little room around which to mount a windscreen. Consequently, while the prior shock-absorbing mount designs may reduce shock-related noise, prior designs have not been conducive to the use of windscreens.

Other devices in the prior art, such as U.S. Pat. No. 5,444,790 to Kogen and British Patent 2,208,577 to Gozzard, disclose windscreen devices that reduce noise in microphones caused by wind. The most effective of such devices typically use a great number of small-diameter flexible filaments, or fur-like materials, to arrest wind noise. However, such an arrangement, while effective against unwanted wind noise, is by its very nature bulky and somewhat voluminous, and therefore cannot be used in combination with existing shock-absorbing mounts.

In my previous patent application, I disclosed a combination shock-absorbing mount and windscreen. However, my present invention is easier to assemble and disassemble in the field than my prior design or any of the known designs, and does not require any tools to replace damaged components. Further, my previous device was not as easily adapted to microphones of various size and not have the universality of the present invention.

Therefore, there is a need for an inexpensive, universal shock-absorbing microphone mount that also includes a windscreen arrangement for reducing wind noise. The device should be well-suited for use outdoors, and with existing boom poles and other mechanical microphone supports. Further, the microphone mount should be easy to adjust to any desired microphone orientation. Still further, the desired device can be used with a wide variety of microphone sizes, and would be able to be manually assembled and disassembled without tools. The present invention accomplishes these objectives.

### SUMMARY OF THE INVENTION

The present device is a mount for a microphone which preferably includes a windscreen. The microphone mount is adapted to be removably affixed to a microphone boom pole. The mount includes preferably at least two resilient microphone supports. Each microphone support includes a resilient microphone ring attached to a plurality of resilient ring bands. The flexibility of the rings allows each ring can accommodate and frictionally retain microphones of various sizes and diameters.

Each microphone support further includes a plurality of ring bands which are each removably fixed, by friction, to posts forming a channel. A plurality of ring bands, preferably numbering four, support the ring away from, and between, the posts. Further, each microphone support is fixed at its lower end to a microphone support base which has least one mounting aperture therein. The base has at least two apertures that are threaded.

The mount further includes an elongated generally cylindrical cage that has a front open end, a rear open end, and an acoustically-permeable rigid wall. A bottom surface of the cage includes a resilient base fixture that includes at least one mounting aperture therein. Preferably the base fixture is made from an elastomeric rubber material that dampens shock and vibration therethrough. A pair of reticulated foam hemispheric end caps are preferably included that are slidably, frictionally retained within the open ends of the cage. The cage is modular and sections of the cage may be added or subtracted as desired by the user.

A rigid, preferably metallic, cage mounting bracket is included which has at least one mounting aperture and includes a pivot mounting means. A rigid mounting post is pivotally and selectively fixed to the pivot mounting means which is removably attached to the cage.

At least one, and preferably two, mounting bolts are included that secure the cage mounting bracket, the resilient base fixture of the cage, and the microphone support base together. As the microphone mount is removably retained within the ring of each microphone support, and the microphone support is affixed to the cage utilizing the mounting bracket and the resilient base fixture of the cage, the microphone is removably retained within the cage. The cage preferably further includes an electric microphone connector which is fixed through the wall of the cage.

A windscreen cover, made of faux fur or other suitable material, is also include. The windscreen cover may be selectively mounted around the cage to provide wind noise dampening. The windscreen cover includes an opening sealable around the cage with a hook-and-loop type fastener, or other suitable closure means.

The present device is an inexpensive shock-absorbing modular microphone mount that also includes an windscreen cover for reducing wind noise in the preferred embodiment. The present device is well-suited for use outdoors, and with existing booms and other mechanical microphone supports. Further, the present device is relatively easy to manufacture and extremely simple to assemble and use, being quickly adjustable to any desired microphone orientation on the boom or other microphone support. The present invention is readily assembled and disassembled by the operator in the field without requiring tools. Further, the present device may be used with a wide variety of microphone sizes, and can be manually assembled and disassembled without tools. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a partially exploded side elevation view of the invention, illustrating a cage and a cover therefore;

FIG. 2 is an exploded view of the invention, illustrating in more detail the components of the invention;

FIG. 3 is a perspective view of a plurality of microphone supports with a microphone shown in phantom outline retained therein;

FIG. 4 is a perspective view of the invention, illustrating the cage as covered by a windscreen cover; and

FIG. 5 is an exploded view of the pivot mounting means of the present invention.

### DETAILED DESCRIPTION OF THE PREFERRED EMBODIMENT

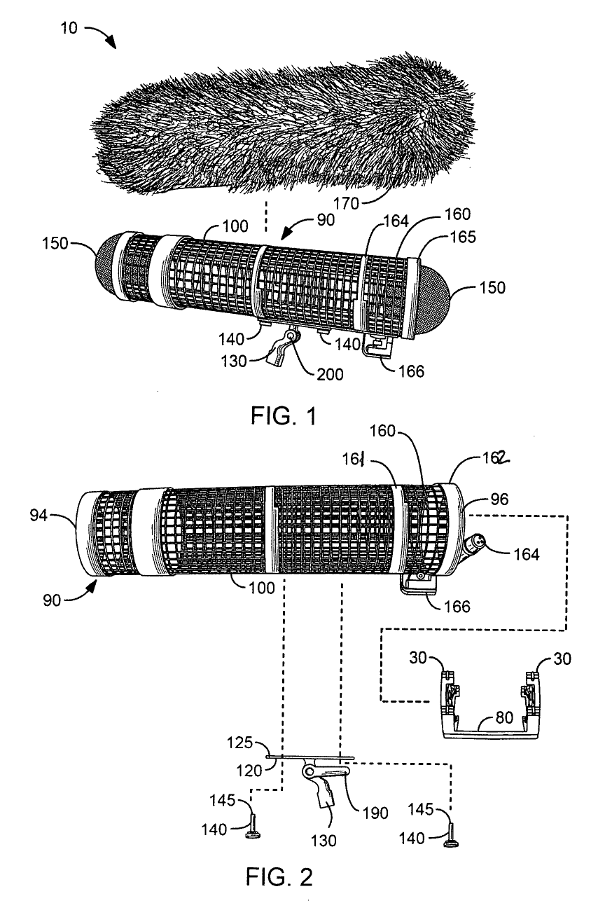

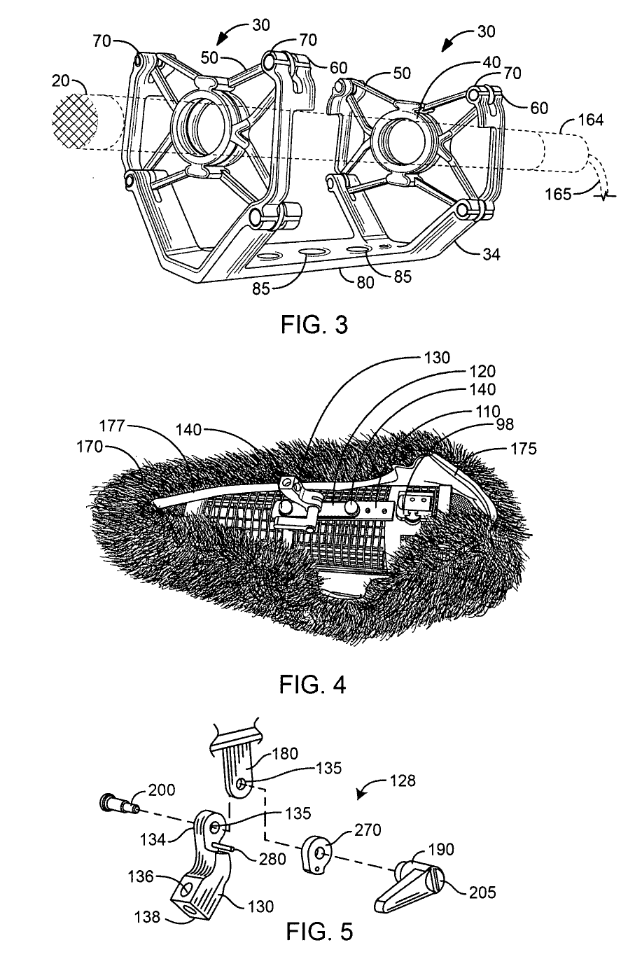

FIGS. 1 and 3 illustrate a mount 10 for supporting a microphone 20. The mount 10 includes at least one, and preferably two, microphone supports 30. The microphone supports 30, which secure the microphone, are enclosed by, and removably attached to the cage 90. Each microphone support 30 comprises a resilient microphone ring 40 attached to a plurality of resilient ring bands 50, each of which are adapted to frictionally enclose and retain the microphone 20 as shown in FIG. 3. Each ring 40 and its connecting ring bands 50 are preferably integrally formed, such as by molding, from an elastomeric rubber material. Each ring 40, because of its resiliency, can accommodate and frictionally retain microphones 20 of various sizes and diameters.

Each microphone support 30 further includes a plurality of ring band posts 60 that are each removably fixed to a post channel 70 by friction as illustrated in FIG. 3. Preferably the ring band posts 60 snap into place, each post channel 70 being resilient and smaller in diameter than the ring band posts 60. The plurality of ring band posts 60, preferably numbering four, support the ring 50 away from the posts 60, and preferably centered between the posts 60. Further, each microphone support 30 is fixed at its lower end 34 to a microphone support base 80 as shown in FIGS. 2 and 3, which has least one mounting aperture 85 therein. The base 80 has preferably at least two apertures 85 that are threaded, the base 80 being a rigid metallic or plastic material.

The mount 10 further includes an elongated generally cylindrical cage 90 that has a front open end 94, a rear open end 96, and an acoustically-permeable rigid wall 100. The wall 100 may be formed of a plastic grid as illustrated in FIG. 1, a perforated sheet (not shown), or a metallic or plastic screen (not shown). A bottom surface 98 of the cage 90 includes a resilient base fixture 110 that includes at least one mounting aperture 115 as shown in FIG. 4. The resilient base fixture 110 is inserted into a slot (not shown) in the cage 90. The base fixture 110 is preferably made from an elastomeric rubber material that dampens shock and vibration therethrough. The elastomeric nature of the base fixture 110 permits the operator to readily remove and insert the base fixture 110 to the cage 90 in the field. A pair of reticulated foam, hemispheric end caps 150 are preferably included that are slidably, frictionally retained on the open ends 94 and 96 of the cage 90 as illustrated in FIG. 1. The end caps are preferably formed with a groove (not shown) for convenient engagement with the end of the cage. The cage 90 encloses the microphone support 30. The cage 90 is modular and a cage section 160, for example, may be added or removed, depending on the needs of the operator at mounting bands 161 and 162, shown in FIG. 1. The mounting bands are preferably formed of elastomeric material and have grooves (not shown) for receiving the ends of the cage sections.

A rigid, preferably metallic, cage mounting bracket 120 is included that has a mounting aperture 125 and includes a pivot mounting means 128 for removably affixing the mounting post to the cage 90, as shown in FIG. 2. A rigid mounting post 130 is removably, pivotally and selectively fixed to the pivot mounting means 128 of the cage 90. The mounting post 130 further includes a threaded aperture 138. The threaded aperture 138 of the mounting post 130 usually receives a boom pole (not shown). The mounting post 128 is illustrated in FIG. 5 and preferably includes an arm 134 having a pivot aperture 135. The pivot mounting means 128 of the includes: a cage mounting bracket 180, a pivot arm 128 which has an aperture 285, as well as a tightening lever 190 that includes an anti-rotation pin or dowel 280. When the lever 190 is tightened, the bolt 200 and the lever 190 may be selectively tightened to secure the position of microphone by preventing pivotal rotation of the pivot arm 130 relative to the cage mounting bracket 120, base fixture 110 and thus, the cage 90. A push button 205 is included to engage and disengage the bolt 200. Clearly, however, other pivot mounting means may be devised and still remain within the spirit and scope of the present invention.

At least one, and preferably two, mounting bolts 140 are included which secure the cage mounting bracket 10, the resilient base fixture 110 of the cage 90, and the microphone support base 80 together (FIGS. 1 and 2). The microphone 20 is fixedly retained within the cage 90, preferably with the longitudinal axis of the microphone 20 and the longitudinal axis of the cage 90 being collinear. The microphone 20 is mounted within the ring 40 of each microphone support 30, and the mounting bolts 140 fix the cage mounting bracket 120 and the resilient base fixture 110 of the cage 90 to the microphone support base 80.

The cage 90 preferably further includes an electric microphone connector that is fixed through the rigid wall 100 of the cage 90. The microphone connector preferably includes an inner connector 164 that has a relatively short flexible conductor 165 (FIG. 3) connected to an outer connector 166 (FIGS. 2 and 3). The inner connector 164 is preferably a female XLR-type connector, suitable for connecting to commonly used microphones 20. The outer connector 166 is preferably a male XLR-type connector.

A windscreen cover 170, made of faux fur or other suitable material, is also included (FIGS. 1 and 4). The windscreen cover 170 may be selectively mounted around the cage 90 to provide wind noise dampening. The windscreen cover 170 includes an opening 175 sealable around the cage 90 with a hook-and-loop type fastener 177, or other suitable closure means (FIG. 4).

While a particular form of the invention has been illustrated and described, it will be apparent that various modifications can be made without departing from the spirit and scope of the invention. For example, the exact material of the windscreen cover 170 may be modified, as may the type of material used for the wall 100. Accordingly, it is not intended that the invention be limited, except as by the appended claims.

I claim:

1. A mount for a microphone for use with a boom comprising:
an elongated cage;
at least one microphone support, each comprising a resilient microphone ring and a plurality of resilient ring bands, said ring adapted to retain the microphone, each microphone support further including a plurality of ring band posts and a post channel, wherein said ring bands affixed to said ring band posts and said ring band posts are affixed to said post channel and said elongated cage having a front and a rear open end, an acoustically-permeable wall, and a base fixture having at least one mounting aperture therein, the resilient base fixture being fixed to said cage;
pivot mounting means removably affixed to said cage
a mounting post having a pivot arm and an aperture for receiving the boom, said pivot arm pivotally and selectively secured relative to said cage by said pivot mounting means; and
at least one means for affixing said mounting post to said cage;

2. The microphone mount of claim 1 wherein each resilient microphone ring and each ring band are made from a rubber material.

3. The microphone mount of claim 1 wherein the number of microphone supports is exactly two and wherein the number of ring bands is exactly four.

4. The microphone mount of claim 1 wherein the resilient base fixture of the cage is made from a rubber material.

5. The microphone mount of claim 1 wherein the microphone support based includes at least one mounting aperture for receiving a mounting bolt.

6. The microphone mount of claim 1 wherein the cage includes two hemispheric end caps, each engageable with either open end of the cage.

7. The microphone mount of claim 1 wherein the cage further includes an electric microphone connector fixed through the rigid wall, the microphone connector including an outer connector and an inner connector, such that the inner connector may be electrically connected to the microphone, and the microphone is electrically connected to the outer connector.

8. The microphone mount of claim 7 wherein the inner connector is a female XLR connector with a short flexible conductor, and wherein the outer connector is a male XLR connector.

9. The microphone mount of claim 1 further including a windscreen cover for selectively mounting around the cage, the windscreen being acoustically permeable but dampening to noise generated by wind.

10. The microphone mount of claim 9 wherein the windscreen cover includes an opening sealable around the cage with a hook-and-loop type fastener.

11. The microphone mount of claim 1 wherein said mounting post further includes a pivot arm connected to said cage.

12. The microphone mount of claim 1 further including a cage mounting bracket wherein the mounting post includes a pivot arm pivotally and removably affixed by said cage mounting bracket to said cage.

13. The microphone mount of claim 1 wherein said mounting post includes an aperture for receiving a boom.

14. The microphone mount of claim 12 wherein said further including an anti-rotation pin wherein said pivot arm receives said anti-rotation pin.

15. The microphone mount of claim 12 further including a tightening lever such that the anti-rotation pin and the lever may be selectively tightened by rotating said lever to prevent e rotation of the pivot arm relative to the mounting post and the pivot arm of the cage mounting bracket.

16. The microphone mount of claim 1 further including at least one additional section of said cage, said sections having a first and second end and at least first and second annular bands, said bands having grooves, said first band is removably affixed to said open end of said cage, said first end of said additional section is received by said groove of said first band and said second end of said additional section is received by said second band.

17. The microphone mount of claim 1 wherein the cage includes two reticulated foam hemispheric end caps, each adapted to be frictionally engaged with either open end of the cage.

18. The microphone mount of claim 16 further including a first and second hemispheric end caps engaged with said first open end of said cage and said second band.

19. The microphone mount of claim 12 wherein said cage mounting bracket is comprised of elastomeric material.
